(19) United States
(12) Patent Application Publication
(10) Pub. No.: US 2017/0191577 A1
(43) Pub. Date: Jul. 6, 2017

(54) Check Valve for Submersible Pump

(71) Applicant: Strataflo Products, Inc., Fort Wayne, IN (US)

(72) Inventor: Bradley A. Fudge, Fort Wayne, IN (US)

(21) Appl. No.: 15/399,542

(22) Filed: Jan. 5, 2017

Related U.S. Application Data
(60) Provisional application No. 62/275,077, filed on Jan. 5, 2016.

(51) Int. Cl. F16K 15/02; F04B 53/10

(52) U.S. Cl. CPC F16K 15/028; F04B 53/10

(57) ABSTRACT

The present invention comprises a two-piece check valve for detachable use with a submersible pump, said check valve comprising a first body piece detachably attached to a second body piece, where the inner face of said first body piece comprises a poppet seat and a portion of the second piece comprises a poppet stem retaining member, and further comprising a poppet with a head and a stem, where the stem slides axially within the stem retaining member, a biasing member is captured between the poppet head and the stem retaining member, and the biasing member biases the poppet head into a closed position against the seat and where a fluid passage exists through the check valve when liquid flow overcomes the biasing member and pushes the poppet into an open position.

### CROSS-REFERENCE TO RELATED APPLICATION

This Application is a non-provisional continuation of, and incorporates in its entirety, previously-filed U.S. Provisional Application Ser. No. 62/275,077, Check Valve for Submersible Pump, and incorporates the same in its entirety.

### BACKGROUND

This invention relates to controlling flow of fluids in a liquid or gas system, and more particularly to a check valve for use in the unidirectional delivery of fluid liquid or fluid gas under pressure from the outlet of a pump, and particularly a submersible pump, to a location outside of the outlet, without allowing substantial backflow of the fluid liquid or fluid gas into the pump.

Check valves are in widespread use for permitting fluids to flow through a passage in one direction while preventing flow in the reverse direction, including in the context of submersible pumps. Most check valves employ a movable poppet urged by a spring to engage a valve seat, thereby closing the valve. When force is exerted against the face of the poppet by fluid in the system moving in the direction permitted by the check valve, and that pressure exceeds the force of the spring, the poppet moves away from the seat, opening the valve.

Check valves are used in a variety of applications. In the application of submersible pumps, particularly submersible pumps for wells, it is known to the art to build backflow preventative structures permanently into the pump outlet. These structures are commonly recognized as insufficient to prevent backflow adequately under the working conditions submersible pumps are often subjected to. As a result, there exists a need in the art for a removable or external check valve, capable of regulating backflow adequately in the normal operating conditions of a submersible pump within a well, and configurable to fit within the outlets of a variety of manufacturers' submersible pumps.

In general use, and particularly in the application of a submersible pump, a removable or external check valve can be exposed to severe environmental conditions, including large pressure fluctuations, temperature fluctuations, and turbulent flow. In some applications, such check valves are subjected to frequent forward and reverse flow cycles. Consequently, the poppet and other internal parts of check valves are in many applications subject to substantial vibrations which can result in noise, damage, or failure. Some valves known in the art include a guide, sometimes called a retaining piece, mounted inside the valve for guiding and limiting movement of the poppet to prevent damage. In valves known to the art, retaining pieces are frequently located so that installation and replacement is difficult, or are flexible in construction or otherwise ill-suited for the severity of the environment. Further, the inaccessibility of the internal parts of check valves known to the art generally necessitates replacement of the entire valve assembly when only one part of the valve, such as the spring, fails.

Further, check valves known to the art are often purpose-built for connection to specifically-sized or specifically configured pipes or conduits. This limits the usefulness and versatility of check valves known to the art, as such valves can only be used in connection with the configuration of pipe or conduit for which they are built. Still further, check valves known to the art require a variety of fabrication techniques to make the different parts that comprise the valve assembly. Parts like the poppet or guide are often molded or cast, while parts like the housing are often machined. The variety of fabrication techniques requires to make the parts of a check valve increases the cost of the valve assembly.

It would a decided advantage to provide a check valve that allows convenient replacement one or more parts internal to the valve, including specifically the poppet and spring. It would further be a decided advantage to provide an improved check valve that can be easily adapted by a user for use with a variety of submersible pump outlets without requiring the purchase of an entire new valve assembly or a new pump. It would further be a decided advantage to provide a check valve wherein most parts can be produced by efficient fabrication techniques, such as machining.

### SUMMARY

Among the several objects of the embodiments of this invention are to provide an improved check valve that allows convenient replacement one or more parts internal to the valve, including specifically the poppet and retaining piece, to provide an improved check valve that can be easily adapted by a user for use with a variety of submersible pump outlets, and to provide a check valve wherein most parts can be machined, reducing the number of fabrication techniques required for the production of the check valve assembly.

In general, a submersible pump check valve according to the present invention comprises a body with a fluid passage extending therethrough from a first end constituting the end of the housing for entry of fluid under pressure to flow through to a second end constituting the end for exit of the housing for fluid under pressure. A portion of the first end interior comprises a poppet seat. The check valve is formed of two or more pieces detachably attached to each other. The poppet assembly, which comprises a poppet with a head and a stem, a stem enclosure, and a biasing member captured between the poppet head and the face of the stem enclosure, fits within the body so that the head of the poppet faces the seat. The poppet stem engages slidably with the stem enclosure. The stem enclosure is formed as part of a member bisecting the fluid passage such that the face of the stem enclosure facing the first end comprises a retaining shelf of sufficient size to retain and support the base of the biasing member. The stem enclosure preferably extends outward from the second end of the body, most preferably in a hex profiled outer face to enable the stem enclosure to have secondary utility as a turning aid for installation of the valve. The biasing member biases the inlet-facing portion of the poppet against the seat. When fluid under pressure flowing from the outlet of a submersible pump in the direction from the first end towards the second end encounters the poppet, the poppet slides away from the seat allowing fluid to enter the valve and pass through it. When pressure is removed, the biasing member presses the poppet head against the seat, substantially preventing the reverse flow of fluid back into the pump outlet. One of the first or second end of the pump further comprises external male threading, preferably of 1.25 inch diameter or other size as may be desired to fit within a submersible pump outlet.

In this way, embodiments of the present invention can be easily dis- and re-assembled for removal, replacement, or service of the internal parts. Further, most of the parts of check valves according to the teachings of the present invention can be manufactured by machining, reducing the need for multiple fabrication techniques. Additionally, check valves as taught herein can be placed within Additionally, one or more pieces of the check valves of the present invention can be replaced with pieces sized or otherwise configured to connect with pipes or conduits of different sizes or different configurations, allowing modularity and the ability to adapt the same valve to several different functions or applications without requiring replacement of the entire valve assembly.

### DESCRIPTION OF THE DRAWINGS

FIG. 1 shows a representative submersible pump in connection with which a check valve according to the present invention could be used;

FIG. 2 shows a a cutaway view of a representative submersible pump with an embodiment of a check valve according to the present invention installed;

FIG. 3 shows a perspective view of one embodiment of a check valve according to the present invention;

FIG. 4 shows an exploded view of one embodiment of a check valve according to the present invention;

FIG. 5 shows a bottom-up view of the second piece of a check valve according to the present invention;

FIG. 6 shows a top-down view of the second piece of a check valve according to the present invention;

FIG. 7 shows a bottom-up view of the first piece of a check valve according to the present invention;

FIG. 8 shows a bottom-up view of the first piece of a check valve according to the present invention.

### DETAILED DESCRIPTION

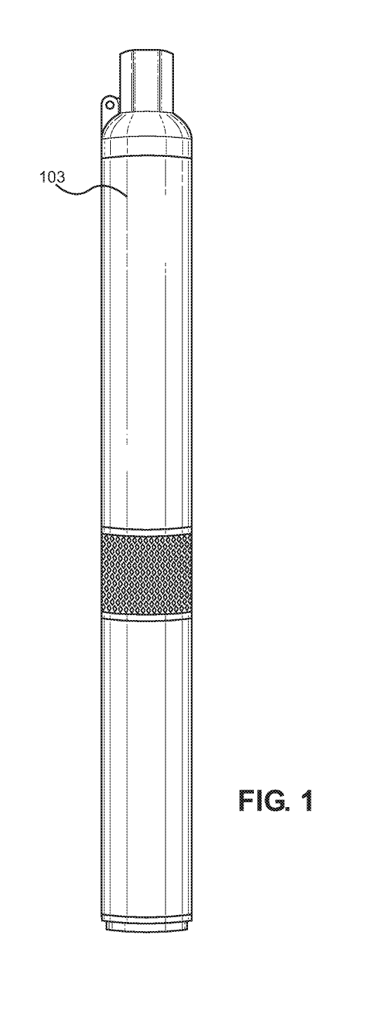

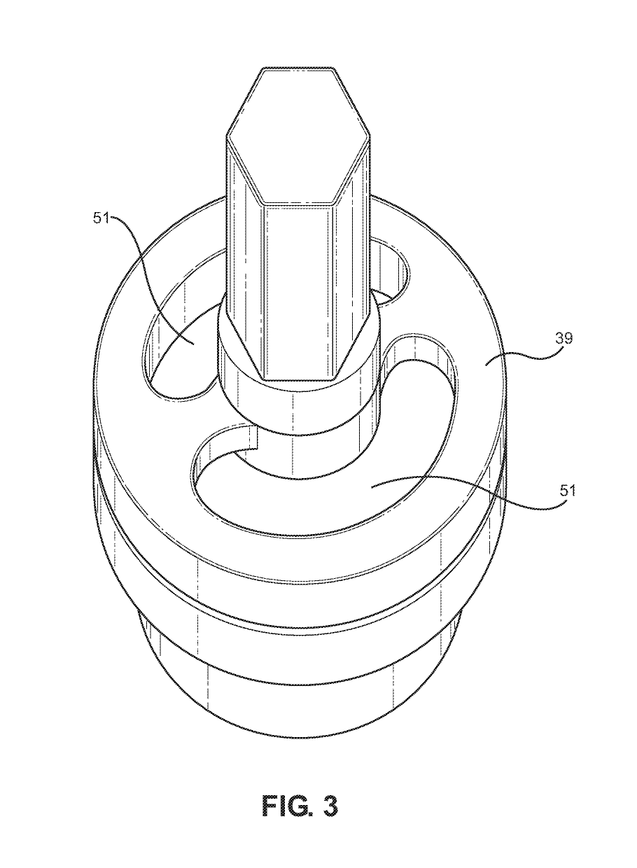

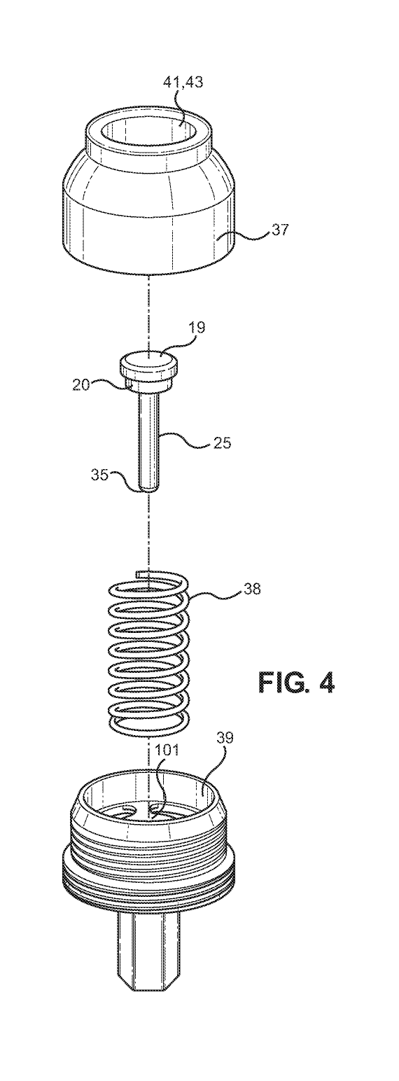

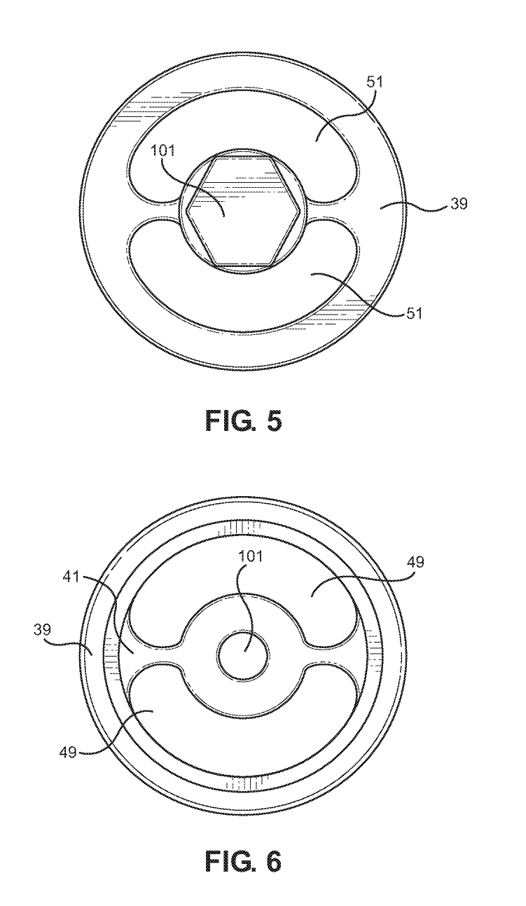

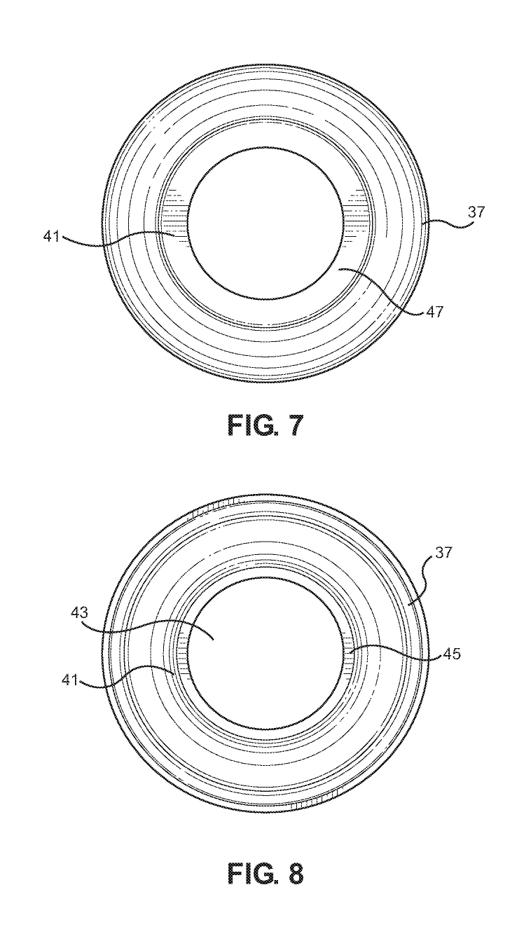

In a preferred embodiment, as shown in FIGS. 1-8, a check valve for submersible pumps of the present invention comprises a two-piece assembly. In this preferred embodiment, the check valve comprises a body comprising a first piece (37) detachably attached to a second piece (39), with a fluid passage (41) running through the first piece (37) and second piece (39).

The first piece (37) comprises a first inlet (43), a first outlet (47) and a portion of the fluid passage (41). A seat (45) is disposed around the inner face of the first inlet (43). In the embodiment shown in FIGS. 1-8, the seat (45) comprises a bevel or a shelf in the inner face of the first inlet (43) configured to mate sealably with a poppet head (19).

The second piece (39) comprises a second inlet (49), a second outlet (51), a portion of the fluid passage (41), and a stem enclosure (101). A portion of the first piece (37) disposed toward the first outlet (47) comprises internal threading, and a portion of the second piece (39) disposed towards the second inlet (49) comprises cooperative external threading such that the first piece (37) and second piece (39) detachably connect by threaded engagement. As will be appreciated by one skilled in the art, such threading may be reversed. In this way, the check valve assembly can be easily disassembled for service, removal, or replacement of internal parts. As will be appreciated by one skilled in the art, a variety of means of mechanical connection may be used to detachably attach the first piece (37) to the second piece (39) within the scope and spirit of this invention. Any form of connection suitable for plumbing or gas flow applications may be used, as will be appreciated by one skilled in the art. Suitable forms of connection include, by way of example, press-on connection, soldered connection, sweated connection, and friction fit connection. As will be appreciated by one skilled in the art, washers, rubber washers, gaskets, cements, epoxies, or sealants may be used to enhance the connection between the first piece (37) and second piece (39).

The stem enclosure (101) comprises a sleeve to slidably retain the poppet stem. The stem enclosure (101) is preferably disposed substantially in the center of the fluid passage defined by the second piece. In the preferred embodiment the stem enclosure (101) is held in axial alignment with the poppet stem by one or more, and in the depicted embodiment, 2, supporting members connecting the stem enclosure (101) to the valve body. In the preferred embodiment, the stem enclosure (101) extends beyond the end of fluid passage. In the preferred embodiment, the external surface of the stem enclosure (101) is configured in a hex profile, which allows it to operate with secondary function as a turning aid for installation of the valve in the outlet of a pump.

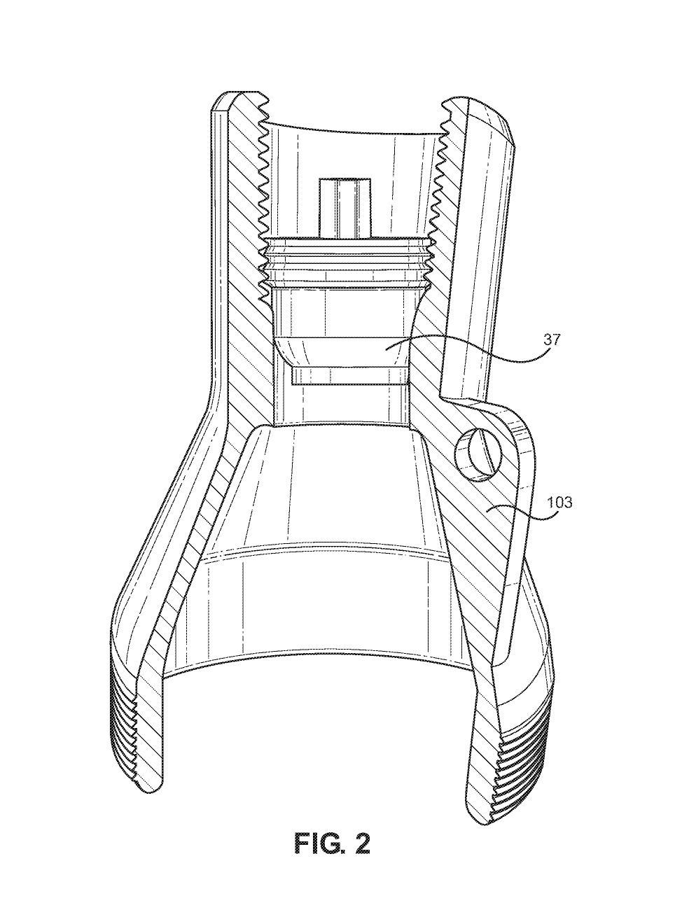

Further, in the preferred embodiment shown in FIGS. 1-8, a portion of the outer circumference of the second piece (39) is adapted for threaded engagement with the outlet of a submersible pump, preferably in standard sizes, and most preferably in the size of 1.25 inch. As shown in FIG. 2 particularly, a portion of the outer circumference of the second piece (39) comprises male threading configured for threaded engagement with the female threading in the outlet of a submersible pump. One skilled in the art would appreciate that a variety of different or alternate configurations could be used to achieve operative between the check valve of the present invention and a submersible pump outlet, including the use of connection types other than threaded connection or differing sizes or configurations. For example, the first piece (37), or second piece (39), or both could be selected or adapted for male or female connection to the outlet of a submersible pump, or could be selected or adapted to connect to the same by way of threading, soldering, friction, cement, adhesive, or other known connection means as would be appreciated by one skilled in the art. By replacing one or more of the first piece (37) or second piece (39) with alternative pieces configured to fit to outlets of different sizes or configurations, or using different connection means, a user may easily adapt the check valve of this embodiment for engagement with a wide variety of submersible pumps.

A poppet assembly is located within the fluid passage (41). The poppet assembly comprises a biasing member (38), and a poppet (25).

A removable poppet (25), comprised of a head (19) and a stem (35), is slidably engaged with the stem enclosure (101). The poppet (25) is positioned so that the stem (35) is within the stem enclosure (101) and the head (19) faces the seat (45). The poppet head (19) is shaped to cooperate with the seat (45) to form a releasable sealed engagement when the biasing member (38) presses the head (19) against the seat (45). A removable biasing member (38) is located between the head (19) and a face of the stem enclosure (101) and adapted to bias the head (19) against the seat (45). In the preferred embodiment, the poppet (25) comprises a collar (20) on the head (19) opposite the face of the head (19) that seals to the seat, which assists the poppet (25) in aligning with the stem enclosure (101) when the poppet (25) is under pressure in the forward flow direction. Optionally, the collar (20) may align with a cooperative bevel in the face of the opening defined by the stem enclosure (101). Preferably, the poppet head (19) is comprised of or coated with rubber.

The biasing member (38) biases the head (19) against the seat (45) such that when fluid under pressure of a desired minimum level moving in the appropriate direction encounters the poppet (25), the poppet (25) slides away from the seat (45) towards the second outlet (51) allowing the fluid to pass through the first inlet (43). As long as sufficient pressure is applied in the appropriate direction, fluid will pass into the first inlet (41), past at least one face of the stem enclosure (101), and exit the valve assembly through the second outlet (51). If pressure in the appropriate direction ceases or pressure from the reverse direction is applied, the head (19) is biased back into substantially sealed engagement with the seat (45), substantially preventing the reverse flow of fluid through the valve.

Embodiments of the present invention can be manufactured or made from a variety of materials, as will be understood by one skilled in the art. Metals and metal alloys such as, for example, carbon steel, impact tested carbon steel, low temperature service carbon steel, stainless steel, malleable iron, non-ferrous metals, and chrome-molybdenum steel, non-metallic substances such as ABS, FRE, HDPFE, tempered glass, PVC, and other plastics, elastomers such as rubber, overmolded metals, and overmolded non-metallic materials, can all be used to for one or more parts of the check valve assembly taught herein, as will be appreciated by one skilled of the art In preferred embodiments, the body of the check valve and the retainer are made of metal, preferably by machining.

Although the invention herein has been described with regard to specific embodiments, it will be understood that the invention is not limited to these embodiments. Alternative materials, manners of assembly or connection, retainer shapes or sizes, poppet shapes or sizes, or biasing means other than those expressly depicted herein may be used within the scope and spirit of this invention.

What is claimed is:

1. A check valve comprising:
(a) a first piece comprising a first inlet and a first outlet opposite said first inlet, wherein said first outlet comprises a seat;
(b) a second piece detachably attached to said first piece, wherein said second piece comprises a second inlet, a second outlet, a stem enclosure, and a submersible pump connection means;
(c) a poppet comprising a head and a stem, wherein said stem is slidably engaged with said stem enclosure; and
(d) a biasing member captured between said poppet head and said stem enclosure, wherein said poppet head is sealedly engaged with said seat when said poppet is biased by said biasing member into a closed position;
(e) wherein said check valve defines a fluid passage between said first inlet at one end and said second outlet at the other end when said poppet is in an open position.

2. The check valve of claim 1, wherein said biasing member comprises a spring.

3. The check valve of claim 2, further comprising a submersible pump detachably attached to said submersible pump connection means.

4. The check valve of claim 3, wherein said submersible pump connection means comprises male threading.

5. The check valve of claim 3, wherein said submersible pump connection means comprises female threading.
